(19) United States
(12) Patent Application Publication
(10) Pub. No.: US 2002/0081013 A1
(43) Pub. Date: Jun. 27, 2002

(54) MULTI-SPECTRAL SEGMENTATION FOR IMAGE ANALYSIS

(76) Inventor: RYAN S. RAZ, TORONTO (CA)

Correspondence Address: RIDOUT & MAYBEE, ONE QUEEN STREET EAST, SUITE 2400, TORONTO, M5C3B1, CA

(21) Appl. No.: 09/009,276

(22) Filed: Jan. 20, 1998

Related U.S. Application Data
(63) Continuation of application No. PCT/CA96/00477, filed on Jul. 18, 1996.
(60) Provisional application No. 60/001,221, filed on Jul. 19, 1995.

(51) Int. Cl. G06K 9/00

(52) U.S. Cl. 382/133; 382/173

(57) ABSTRACT

A method for segmenting spectrally-resolved images. The first step comprises acquisition of three images of the same micrographic scene. Each image is obtained using a different narrow band-pass optical filter which has the effect of selecting a narrow band of optical wavelengths associated with distinguishing absorption peaks in the stain spectra. The choice of optical wavelength bands is guided by the degree of separation afforded by these peaks when used to distinguish the different types of cellular material on the slide surface. By combining these images in a particular fashion, it is possible to achieve a high degree of success in separating the cervical cell from the background and the nuclei from the cytoplasm.

### FIELD OF THE INVENTION

The present invention relates to automated diagnostic systems, and more particularly to a system for multi-spectral segmentation for analyzing microscopic images.

### BACKGROUND OF THE INVENTION

Automated diagnostic systems in medicine and biology often rely on the visual inspection of microscopic images. Known systems attempt to mimic or imitate the procedures employed by humans. An appropriate example of this type of system is an automated instrument designed to assist a cytotechnologist in the review diagnosis of Pap smears. In its usual operation such a system will rapidly acquire microscopic images of the cellular content of the Pap smears and then subject them to a battery of image analysis procedures. The goal of these procedures is the identification of images that are likely to contain unusual or potentially abnormal cervical cells.

The image analysis techniques utilized by these automated instruments are similar to the procedures consciously, and often unconsciously, performed by the human cytotechnologist. There are three distinct operations that must follow each other for this type of evaluation: (1) segmentation; (2) feature extraction; and (3) classification.

The segmentation is the delineation of the objects of interest within the micrographic image. In addition to the cervical cells required for an analysis there is a wide range of “background” material, debris and contamination that interferes with the identification of the cervical cells and therefore must be delineated. Also for each cervical cell, it is necessary to delineate the nucleus with the cytoplasm.

The Feature Extraction operation is performed after the completion of the segmentation operation. Feature extraction comprises characterizing the segmented regions as a series of descriptors based on the morphological, textural, densitometric and calorimetric attributes of these regions.

The Classification step is the final step in the image analysis. The features extracted in the previous stage are used in some type of discriminant-based classification procedure. The results of this classification are then translated into a “diagnosis” of the cells in the image.

Of the three stages outlined above, segmentation is the most crucial and the most difficult. This is particularly true for the types of images typically encountered in medical or biological specimens.

In the case of a Pap smear, the goal of segmentation is to accurately delineate the cervical cells and their nuclei. The situation is complicated not only by the variety of cells found in the smear, but also by the alterations in morphology produced by the sample preparation technique and by the quantity of debris associated with these specimens. Furthermore, during preparation it is difficult to control the way cervical cells are deposited on the surface of the slide which as a result leads to a large amount of cell overlap and distortion.

Under these circumstances segmentation operation is difficult. One known way to improve the accuracy and speed of segmentation for these types of images involves exploiting the differential staining procedure associated with all Pap smears. According to the Papanicolaou protocol the nuclei are stained dark blue while the cytoplasm is stained anything from a blue-green to an orange-pink. The Papanicolaou Stain is a combination of several stains or dyes together with a specific protocol designed to emphasize and delineate cellular structures of importance for pathological analysis. The stains or dyes included in the Papanicolaou Stain are Haematoxylin, Orange G and Eosin Azure (a mixture of two acid dyes, Eosin Y and Light Green SF Yellowish, together with Bismark Brown). Each stain component is sensitive to or binds selectively to a particular cell structure or material. Haematoxylin binds to the nuclear material colouring it dark blue. Orange G is an indicator of keratin protein content. Eosin Y stains nucleoli, red blood cells and mature squamous epithelial cells. Light Green SF yellowish acid stains metabolically active epithelial cells. Bismark Brown stains vegetable material and cellulose.

The combination of these stains and their diagnostic interpretation has evolved into a stable medical protocol which predates the advent of computer-aided imaging instruments. Consequently, the dyes present a complex pattern of spectral properties to standard image analysis procedures. Specifically, a simple spectral decomposition based on the optical behaviour of the dyes is not sufficient on its own to reliably distinguish the cellular components within an image. The overlap of the spectral response of the dyes is too large for this type of straight-forward segmentation.

### BRIEF SUMMARY OF THE INVENTION

It has been found that although the stains according to the Papanicolaou protocol have evolved principally for the benefit of the cytotechnologist, computerized segmentation algorithms can employ this protocol to good effect if handled properly.

The present invention provides a multi-spectral segmentation method particularly suited for Papanicolaou-stained gynaecological smears. The multi-spectral segmentation method is suitable for use in the automated diagnosis and evaluation of Pap smears.

Micro-spectrophotometric investigation of Papanicolaou-stained cellular samples has established that there is a series of narrow spectral wavelength bands that can maximize the contrast between the three principal cellular components of the epithelial cell images; the nucleus, the cytoplasm and the background. At 570 nm the nuclei display maximum contrast against the cytoplasm. At 530 nm and 630 nm both varieties of cytoplasm are individually found to have maximal contrast against the image background.

The method according to the present invention uses these three optical wavelength bands to segment the Papanicolaou-stained epithelial cells in digitized images. In a preferred embodiment, the present invention comprises a combination of a specialized imaging procedure and an executable algorithm. The method includes standard segmentation operations, for example erosion, dilation, etc., together with a careful linear discriminant analysis in order to identify the location of cellular components.

The first step according to the method comprises the acquisition of three images of the same micrographic scene. Each image is obtained using a different narrow band-pass optical filter which has the effect of selecting a narrow band of optical wavelengths associated with distinguishing absorbtion peaks in the stain spectra. The choice of optical wavelength bands is guided by the degree of separation afforded by these peaks when used to distinguish the different types of cellular material on the slide surface. By combining these images in a particular fashion, it is possible to achieve a high degree of success in separating the cervical cell from the background and the nuclei from the cytoplasm.

In a first aspect, the present invention provides a method for segmenting spectrally-resolved images, said method comprising the steps of: (a) forming an absorption image from each of said spectrally-resolved images; (b) generating absorption ratio images by forming ratios from selected pairs of said absorption images; (c) applying a linear discriminant analysis to said absorption ratio images to produce one or more segmentation output maps.

In a second aspect, the present invention provides a system for segmenting spectrally-resolved images, said system comprising: (a) input means for inputting a plurality of spectrally-resolved images; (b) means for forming an absorption image from each of said spectrally-resolved images; (c) means for generating absorption ratio images by forming ratios from selected pairs of said absorption images; (d) linear discriminant analysis means for analyzing said absorption ratio images to produce one or more segmentation output maps.

A preferred embodiment of the present invention will now be described by way of example, with reference to the following specification, claims and drawings.

### BRIEF DESCRIPTION OF THE DRAWINGS

FIG. 1 is a block diagram of a multi-spectral segmentation method according to the present invention;

FIG. 2 is a block diagram showing production of absorbtion maps for FIG. 1;

FIG. 3 is a block diagram showing production of absorbtion ratio maps for FIG. 1;

FIG. 4 is a graphical representation of linear discriminant analysis according to the present invention; and

FIGS. 5i-5v show in flow chart form a multi-spectral segmentation method according to the present invention.

### DETAILED DESCRIPTION OF THE PREFERRED EMBODIMENT

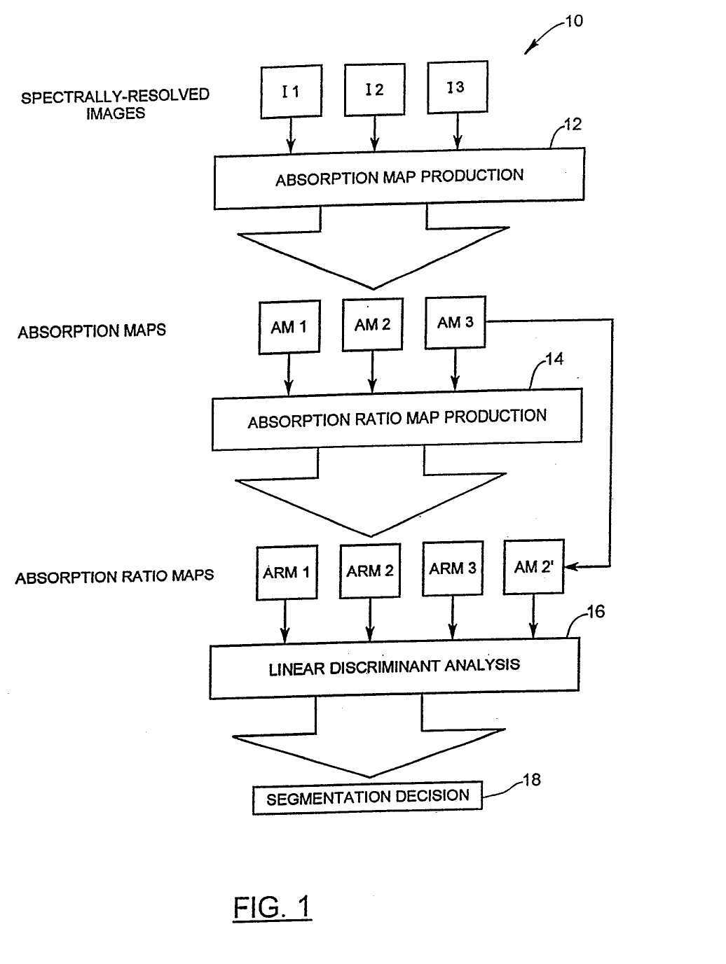

Reference is first made to FIG. 1 which depicts a multi-spectral segmentation method 10 according to the present invention. Preferably, the multi-spectral segmentation method 10 comprises a routine which is suitable for hardware-encoding, i.e. embedded in logic (e.g. Field Programmable Gate Array or FPGA logic) for a special-purpose computer. A suitable hardware architecture is described in applicant's co-pending international patent application entitled an IMAGE PREPROCESSOR FOR IMAGE ANALYSIS and filed simultaneously herewith.

Referring to FIG. 1, the multi-spectral segmentation method 10 operates on three spectrally resolved images I1, 12, I3. The images comprise digitized scans of cellular specimens and preferably are generated by a digitizing camera of known design. It has been found that for Papanicolaou-stained cellular samples there is a series of narrow spectral wavelength bands which enhance the contrast between the three principal cellular components of the epithelial cell images: the nucleus, the cytoplasm and the background. The first image I1 is scanned at 570 nanometres (nm) in order to enhance the contrast of the cytoplasm against the image background. The second image I2 is scanned at 570 nm in order to enhance the contrast of the nuclei against the cytoplasm. Similarly, the third image I3 is scanned at 630 nm to enhance the contrast between the cytoplasm and the image background. It will be understood that the Papanicolaou staining protocol produces two stained cytoplasms which are of interest.

As shown in FIG. 1, the multi-spectral segmentation method 10 comprises three principal steps or operations 12, 14, 16 that are applied to images in order to produce a segmentation decision denoted by 18. (The principal function of the multi-spectral segmentation routine is to delineate objects of interest within the digitized images of the cellular specimens.) Referring to FIG. 1, the first step 12 comprises processing the spectrally resolved images I1, I2, I3 to produce a series of absorbtion maps AM1, AM2, AM3, respectively. The second step 14 involves combining the three absorbtion maps AM1, AM2, AM3 (produced in step 12) to generate three absorbtion ratio maps ARM1, ARM2, ARM3. The third step 16 in the multi-spectral segmentation method 10 involves performing a four-dimensional linear discriminant analysis utilizing the three absorbtion ratio maps ARM1, ARM2, ARM3 and one of the absorbtion maps, e.g. AM2 as shown in FIG. 1.

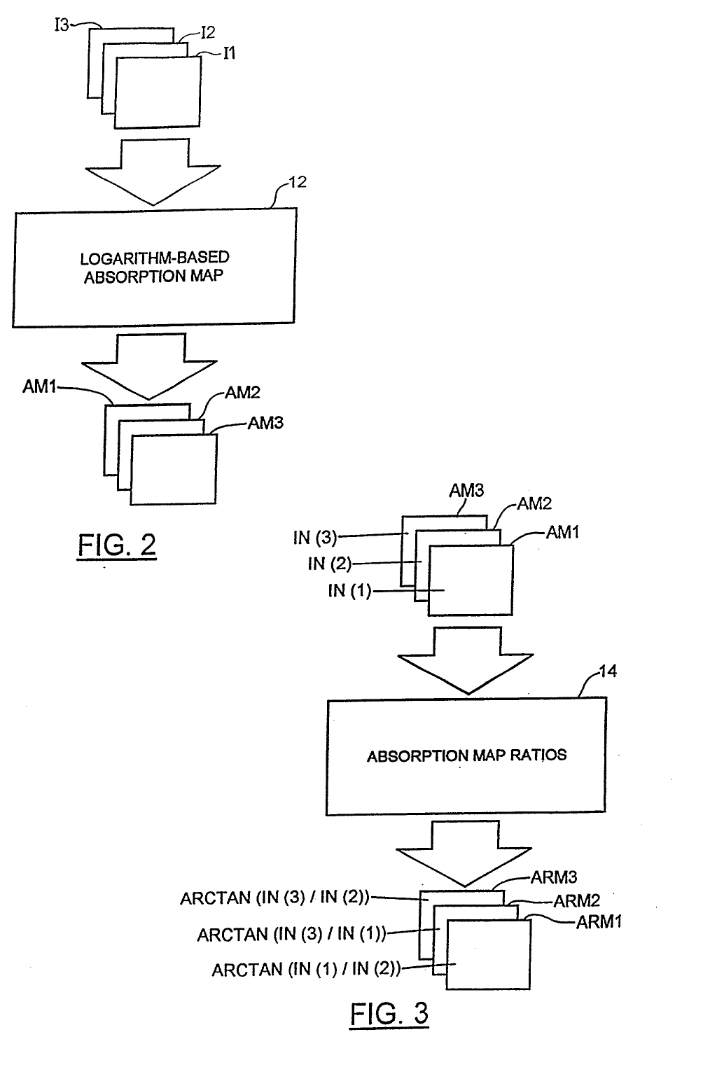

The first step 12 for producing the absorption maps AM1, AM2 and AM3 is depicted in FIG. 2. The operation in this step 12 relies on the observation that the light intensity images I1, I2, I3 generated by the digital camera must follow the known Lambert's Law of optical absorbtion so that the intercepted light intensity is given by the following expression:

I=Iₒexp(−αx) (1)

In expression (1), the parameter I is the intercepted light intensity, Iₒ is the incident intensity, a is the characteristic absorbtion coefficient of the material and x is its thickness. By taking the logarithm of each of the three images I1, I2 and I3, absorption maps AM1, AM2 and AM3 are produced that are proportional to x as shown in FIG. 2 and given by the following expression:

In(I)=In(Iₒ)αx (2)

Referring to FIG. 2, the absorption maps AM1, AM2, AM3 are produced from the application of expression (2) to the spectrally resolved images I1, I2 and I3 in block 12.

As described with reference to FIG. 1, the three absorption maps AM1, AM2, AM3 are combined to produce three absorption ratio maps ARM1, ARM2, ARM3. The operation 14 for producing the absorption ratio maps ARM1, ARM2, ARM3 is shown in more detail in FIG. 3 and involves applying the following scaling relation:

$$Ratio Map = arctan \frac{In ( 1 )}{In ( 2 )} \qquad ( 3 )$$

The absorption ratio maps ARM1, ARM2, ARM3 produced through expression (3) have the advantage of being independent of the local thickness of the biological material. As shown in FIG. 3, the first ratio map ARM1 is derived from the first and second absorption maps AM1 and AM2, the second ratio map ARM2 is derived from the first and third absorption maps AM1 and AM3, and the third ratio map ARM3 is derived from the second and third absorption maps AM2 and AM3.

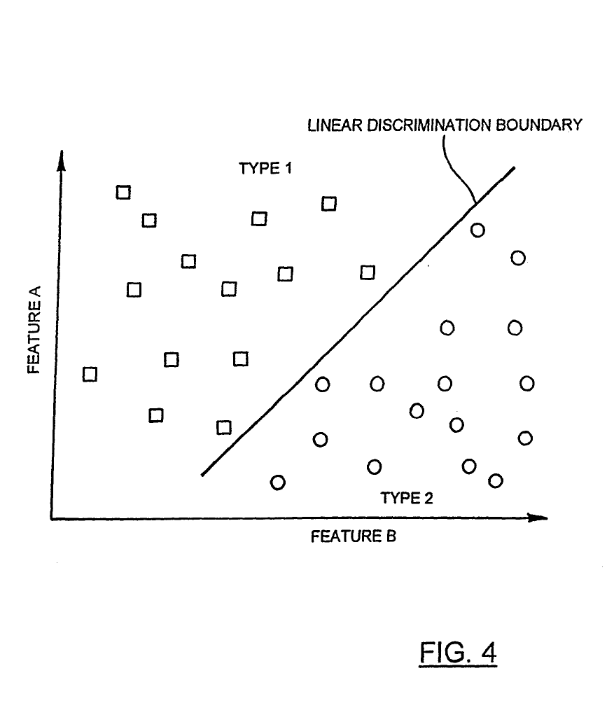

As described above, the third step comprises applying a four-dimensional linear discriminant analysis to the three absorbtion ratio maps ARM1, ARM2 and ARM3 and one of the absorbtion maps AM2. The purpose of this step is to provide the optimal classification of cellular material based on absorbtion characteristics alone. An example of the two-dimensional counterpart for this type of analysis is illustrated in FIG. 4. For the two-dimensional analysis, the two characteristic measures, i.e. FEATURE A and FEATURE B, are enough to provide a proper discrimination between two types of material.

According to this aspect of the invention, linear discriminant analysis for the segmentation of cytoplasm comprises four dimensions as follows: (1) arctan (In (1)/In(2)); (2) arctan (In(3)/In(2)); (3) arctan (In(3)/In(1)); and (4) In(2). The result of the linear discriminant analysis is the delineation between the nuclei and the cytoplasm. In the present instance, the linear discriminant analysis is designed to delineate between the nuclear material, the first cytoplasm material and the second cytoplasm material as defined according to the Papanicolaou staining protocol.

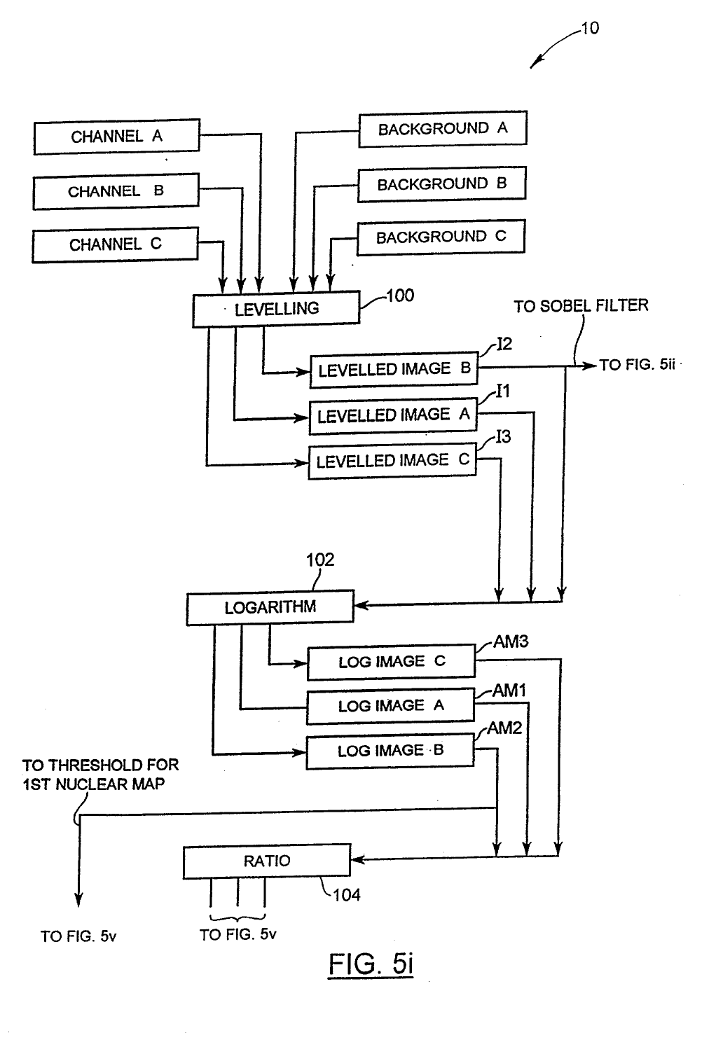

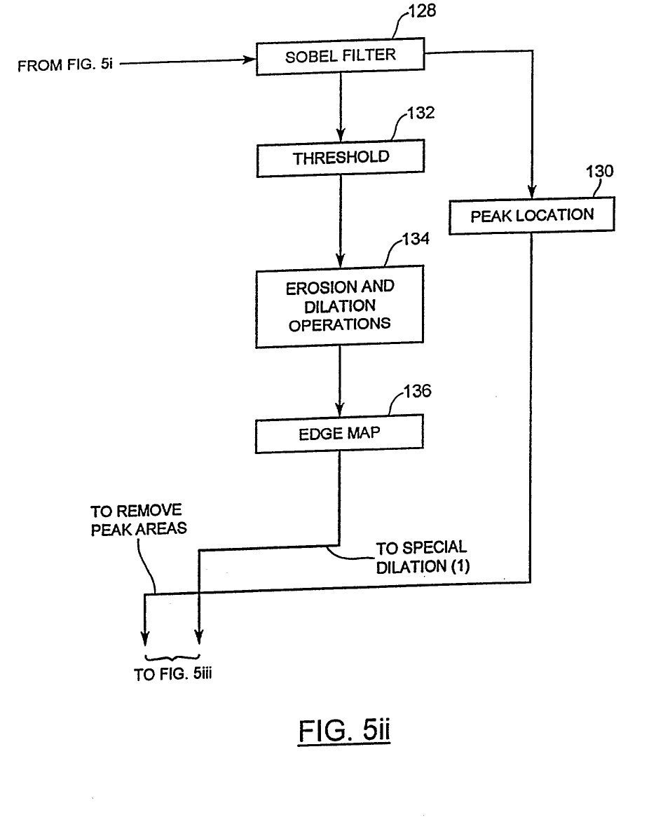

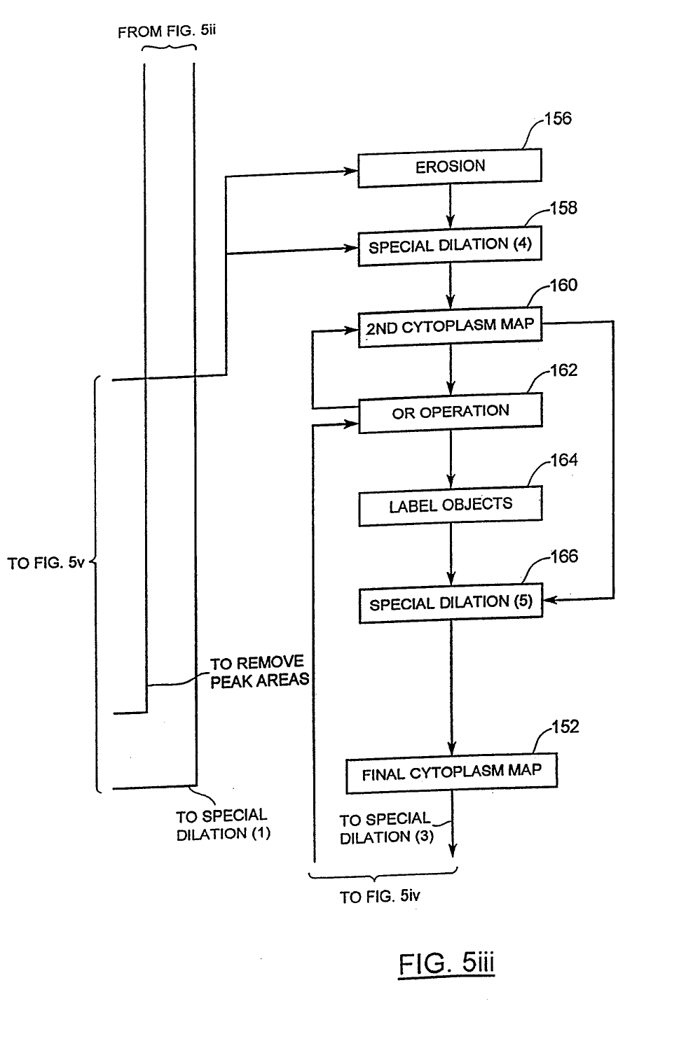

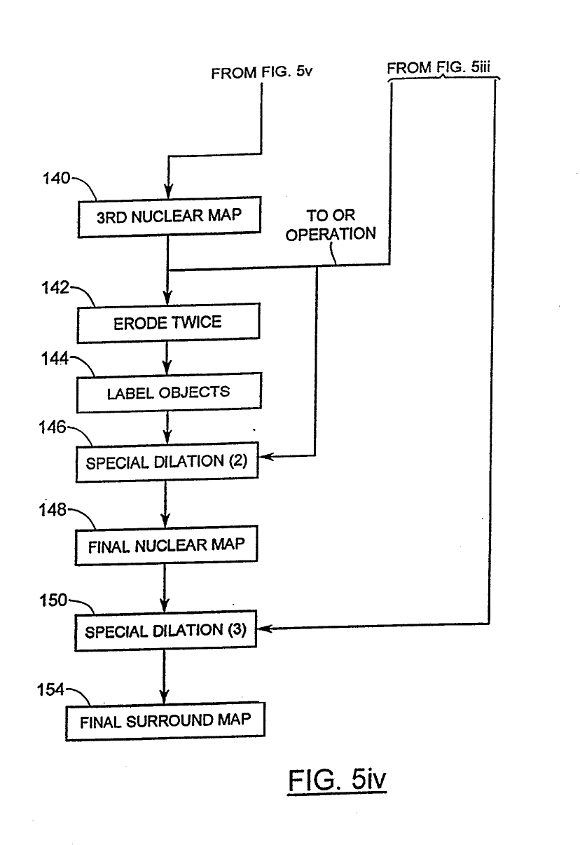

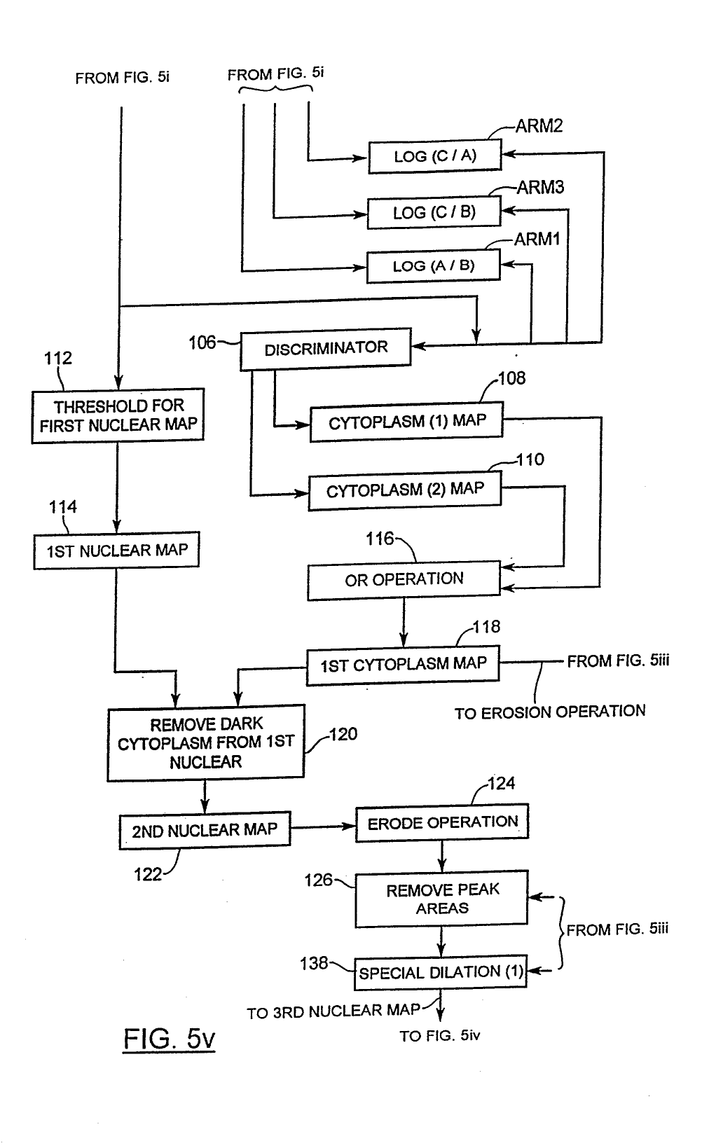

Reference is next made to FIG. 5 which shows in more detail the Multi-Spectral Segmentation method or routine 10 according to the present invention. The principal function of the segmentation method 10 is the delineation of the objects of interest within the micrographic images, in this instance, nuclear and cytoplasm material in cellular Pap smears.

The first operation performed by the multi-spectral segmentation method 10 is a levelling operation 100. The levelling operation 100 comprises an image processing procedure which removes any inhomogenities in the illumination of the cellular images I1, I2, and 13 received on Channels A, B, C, respectively, from the digitizing camera (not shown). The levelling operation 100 utilizes “background” images, i.e. those that do not contain any cellular material, in order to remove the inhomogenities. One skilled in the art will be familiar with the implementation of the levelling operation and therefore additional description for this operation is not needed.

Next, the levelled images, i.e. I1, I2 and I3, are processed by a logarithm module 102. The logarithm module 102 corresponds to the absorption map generation step 12 described above with reference to FIGS. 1 and 2. The module 102 utilizes the natural logarithm function to produce the absorbtion maps. AM1, AM2 and AM3 from the levelled images I1, I2 and I3.

The multi-spectral segmentation routine 10 then calls a ratio module 104 which provides the absorption ratio map production operation described above. The ratio module 104 takes a logarithmic ratio of each of the two-image combinations, i.e. AM1/AM2, AM2/AM3 and AM1/AM3, in order to eliminate the thickness-dependence of the absorbtion maps AM1, AM2, AM3. The output of the ratio module 104 is the absorption ratio maps ARM1, ARM2 and ARM3.

The next step in the segmentation routine 10 comprises the discriminator operation 106. As described above, the routine 10 utilizes a four-dimensional linear discriminant analysis. The discriminator 106 comprises a module that uses the four absorbtion maps to identify the material in an image, i.e. discriminant between the nuclear material and the two types of cytoplasm material. The four inputs to the discriminator 106 are the three absorption ratio maps generated by module 104:

(1) arctan (In(I1)/In(I2))

(2) arctan (In(I3)/In(I2))

(3) arctan (In(I3)/In(I1))

and the fourth dimension is provided by the second absorption map AM2 (i.e. In(I2)). As shown in FIG. 5v, the output from the discriminator 106 is two binary images comprising a first cytoplasm (1) map 108 and a second cytoplasm (2) map 110. The two cytoplasm maps 108, 110 correspond to the two types of cytoplasm material derived from the Papanicolaou staining protocol. Preferably, the discriminator 106 is implemented using a “look-up” table structure in which the pixels provide addressing into the table in order to look-up the identification of the material of interest, e.g. cytoplasm 1 material or cytoplasm 2 material. Knowing the four inputs to the discriminator module 106 as described above, the implementation of the discriminator 106 is within the understanding of one skilled in the art.

As shown in FIGS. 5i and 5v, the second absorption map AM2 also provides an input to a threshold module 112. The threshold module 112 applies a threshold to the second absorption map AM2 which divides the absorption map AM2 into regions that have a pixel value over a particular number (the threshold number) from those whose value is under the threshold number in order to delineate the nuclear material in the image map AM2. The output from the threshold module 112 is a 1st nuclear map 114. The 1st nuclear map 114 comprises a binary (two-level) image and is used in further identification operations as will be described below.

Referring to FIG. 5v, the first and second cytoplasm maps 108, 110 provide the inputs to an OR module 116. The function of the OR module 116 is to logically OR the binary image inputs, i.e. cytoplasm maps 108, 110. The logic OR operation produces an output binary image comprising the logical OR of the two cytoplasm maps 108, 110 and designated a 1st cytoplasm map 118.

As shown in FIG. 5v, the 1st cytoplasm map 118 provides an input to a module 120. The other input for the module 120 is the 1st nuclear map 114 which was generated by the threshold module 112. The module 120 compares the 1st Nuclear map 114 with the 1st cytoplasm map 118 in order to eliminate areas in the 1st nuclear map 114 that are dark cytoplasm. The output from the module 120 is a 2nd nuclear map 122.

The 2nd nuclear map 122 provides the input to an erode module 124. The module 124 performs an erosion operation on the 2nd nuclear map 122. The erosion operation comprises a standard image processing operation and is typically applied to binary images or maps. The erosion operation applies a rule to determine whether a particular pixel in the binary image should be “ON” or “OFF”, that is, take the value of zero or one. In the case of erosion, the pixels of interest in the binary image are ON, and the determination is whether the pixel remains ON or is turned OFF. This determination is based on the binary state of the adjacent pixels, as will be understood by one skilled in the art. The erosion operation is used to “clean-up” the segmentation results by quickly extinguishing small random pixels that have inadvertently been identified as nuclei, etc. The binary image output from the erosion module 124 provides one input to a remove peak areas module 126. The other input for the module 126 is derived from the levelled image I2 (FIG. 5i).

As shown in FIGS. 5i and 5ii, the levelled image I2 also goes to a Sobel filter module 128. The Sobel filter 128 performs a standard gradient filter technique. The output from the Sobel filter 128 goes to a peak location module 130. The function of the peak location module 130 is to locate the highest values of the pixels in the filtered image I2′. The output from the peak location module 130 provides the other input to the remove peak areas module 126. The remove peak areas module 126 compares the 2nd nuclear map 122 with the peaks in the Sobel map in order to remove small and dark debris.

Referring back to FIG. 5ii, the output from the Sobel filter module 128 also goes to a threshold module 132. The threshold module 132 applies a threshold in order to divide the Sobel map image (i.e. output from Sobel filter 128) into regions that have a pixel value between a lower and upper threshold and those that do not fall within this range of values, typically fixed between 32 and 200. The output from the threshold module 132 goes to an erosion and dilation operations module 134. The erosion and dilation operations are standard image processing techniques, and the erosion operation is described above. The dilation operation is similar to the erosion operation except that the rule is inverted to apply to “OFF” pixels and the number of adjacent “ON” pixels. The effect of the dilation operation is to gradually increase the size of the “ON” regions in a binary image as will be apparent to one skilled in the art. The output from the erosion and dilation module 134 is an edge map image 136 of the image I2.

Referring to FIG. 5v, the edge map 136 provides one input to a special dilation (1) module 138. The other input for the special dilation (1) module 138 is the output from the remove peak areas module 126 (i.e. the 2nd nuclear map 122 with the small and dark debris removed). The special dilation (1) module 138 performs a dilation operation that employs the rule that the dilated regions will not go outside the boundaries of the edge map 136. In known manner, the dilation operation “expands” a region of interest in a digital image as described above. The result of the special dilation (1) module 138 is a 3rd nuclear map denoted by reference 140 in FIG. 5iv.

Referring to FIG. 5iv, the 3rd nuclear map 140 goes to an erode twice module 142. The erode module 142 in known manner twice performs the erosion operation on the nuclear map 140. The twice eroded nuclear map then goes to a label objects module 144. The label objects module 144 attaches a unique numeric label to all of the pixels that form a distinct region (i.e. within a boundary) in the twice eroded nuclear map. In this instance, the distinct regions of interest comprise nuclei and the label objects module 144 assigns a unique identifier to each nuclear region in the nuclear map. This allows each distinct region, i.e. nuclei, in the nuclear map to be identified in subsequent operations. It will be appreciated that as operations are performed on labelled regions those regions may gain or lose pixels.

As shown in FIG. 5iv, the output from the label objects module 146 goes to a special dilation (2) module 146. The other input to the special dilation (2) module 146 is provided by the 3rd nuclear map 140. The special dilation (2) module 146 performs a dilation operation and employs the rule that the dilated regions will not go outside the 3rd nuclear map 140. The result for the special dilation (2) module 146 is a final nuclear image map 148.

As shown in FIG. 5iv, the multi-spectral segmentation routine 10 includes another special dilation (3) module 150 which applies a dilation operation to the final nuclear map 148 and a final cytoplasm map 152 to generate a final surround map 154. The special dilation (3) module 150 performs a dilation operation that employs the rule that the dilated regions will not go outside the final cytoplasm map 152. The final surround map 154 comprises a map in which each nuclei is associated with a portion of the cytoplasm.

Referring to FIG. 5iii, the final cytoplasm map 152 is generated from the 1st cytoplasm map 118 (FIG. 5v). The 1st cytoplasm map 118 is processed by an erosion module 156 and a special dilation (4) module 158. The special dilation (4) module 158 performs a dilation operation that employs the rule that the dilated regions will not go outside the 1st cytoplasm map 118. The result of the erosion module 156 is to gradually reduce size and regularize the shape of the cytoplasm regions of the 1st cytoplasm map 118, while the result of the dilation module 158 is to gradually increase the size of the cytoplasm regions in the 1st cytoplasm map 118. By applying the erosion operation a few times, small and unimportant regions are effectively removed from the binary map. The dilation operation is then applied successively to “re-grow” the remaining regions in the binary image back to their former dimensions.

The output from the dilation module 158 is a 2nd cytoplasm map 160. Next, the 2nd cytoplasm map 160 is logically OR'd with the 3rd nuclear map 140 (FIG. 5iv) by a logical OR module 162. The output from the OR module 162 is then applied to a label objects module 164. The label objects module 164 for the cytoplasm map attaches a unique numeric label to all of the pixels that form a distinct region (i.e. within a boundary) in the cytoplasm map. In the present instance, distinct regions of interest comprise cytoplasm material. This allows each distinct region in the cytoplasm map to be identified in subsequent operations. The special dilation (5) module 166 performs a dilation operation that employs the rule that the dilated regions will not go outside the 2nd cytoplasm map 160. The output from the special dilation (5) module 166 is the final cytoplasm map 152.

The final surround map 154 (and final cytoplasm map 152 and final nuclear map 148) produced by the multi-spectral segmentation process 10 are available for further processing, i.e. feature extraction and classification, in order to identify unusual or potentially abnormal cellular structures or features.

Summarizing, the multi-spectral segmentation method or routine according to the present invention has the following advantages. First, the method reduces the degree of error typically associated with the segmentation decisions by correlating a series of observations concerning the distribution pattern of material absorbtion. It is a feature of the present invention that the method is well-suited for a hardware-encoded implementation, for example using Field Programmable Gate Array(s). Field Programmable Gate Arrays (FPGA's) comprise integrated circuit devices that are programmable and provide execution speeds that approach the levels of speed expected from a dedicated or custom silicon device. A hardware-encoded implementation enables the routine to operate at maximum speed in making the complex decisions required. Secondly, the-method is applicable to a multiplicity of similar types of discriminant analysis. For example as further experimental data is tabulated and evaluated more complex discriminant hyper-surfaces can be defined in order to improve segmentation accuracy. Accordingly, the description of the decision hyper-surface can be modified through the adjustment of a table of coefficients.

It is therefore to be understood that the foregoing description of the preferred embodiment of this invention is not intended to be limiting or restricting, and that various rearrangements and modifications which may become apparent to those skilled in the art may be resorted to without departing from the scope of the invention as defined in the claims.

What is claimed is:

1. A method for segmenting spectrally-resolved images, said method comprising the steps of:
(a) forming an absorption image from each of said spectrally-resolved images;
(b) generating absorption ratio images by forming ratios from selected pairs of said absorption images;
(c) applying a linear discriminant analysis to said absorption ratio images to produce one or more segmentation output maps.

2. The segmentation method as claimed in claim 1, wherein said step of forming an absorption image comprises taking the natural logarithm of a spectrally-resolved image.

3. The segmentation method as claimed in claim 2, wherein said step of generating an absorption ratio image comprises forming a ratio from two of said absorption images.

4. The segmentation method as claimed in claim 3, wherein said linear discriminant analysis comprises a four-dimensional analysis.

5. The segmentation method as claimed in claim 4., wherein said four-dimensional linear discriminant analysis operates on four inputs comprising three absorption ratio images and one absorption image.

6. The segmentation method as claimed in claim 5, wherein said four-dimensional linear discriminant analysis utilizes a look-up table and said inputs provide addresses for addressing said look-up table.

7. The segmentation method as claimed in claim 1, wherein said spectrally-resolved images comprise a first image scanned at 530 nanometres, a second image scanned at 570 nanometres and a third image scanned at 630 nanometres.

8. The segmentation method as claimed in claim 7 as applied to images of Papanicolaou-stained cells.

9. The segmentation method as claimed in claim 1, wherein said segmentation maps include a nuclear map.

10. The segmentation method as claimed in claim 9, wherein said segmentation maps include a cytoplasm map.

11. The segmentation method as claimed in claim 10, further including the step of dilating said nuclear map and said cytoplasm map to form a surround map.

12. A system for segmenting spectrally-resolved images, said system comprising:
(a) input means for inputting a plurality of spectrally-resolved images;
(b) means for forming an absorption image from each of said spectrally-resolved images;
(c) means for generating absorption ratio images by forming ratios from selected pairs of said absorption images;
(d) linear discriminant analysis means for analyzing said absorption ratio images to produce one or more segmentation output maps.

13. The system as claimed in claim 12, wherein said system is implemented as a field programmable gate array.

14. The system as claimed in claim 12, wherein said spectrally-resolved images comprise a first image scanned at 530 nanometres, a second image scanned at 570 nanometres and a third image scanned at 630 nanometres.

15. The system as claimed in claim 14, wherein said images comprise scanned Papanicolaou-stained cells.
